(19) United States
(12) Patent Application Publication
(10) Pub. No.: US 2016/0175632 A1
(43) Pub. Date: Jun. 23, 2016

(54) Identification Sleeve Installation and Inspection Methods

(71) Applicant: Victaulic Company, Easton, PA (US)

(72) Inventors: Thomas C. Savage, Doylestown, PA (US); Lawrence W. Thau, JR., Flemington, NJ (US)

(21) Appl. No.: 15/057,777

(22) Filed: Mar. 1, 2016

Related U.S. Application Data
(62) Division of application No. 14/178,915, filed on Feb. 12, 2014.
(60) Provisional application No. 61/765,233, filed on Feb. 15, 2013.

(51) Int. Cl. A62C 35/68; G09F 3/00; F16L 11/12

(52) U.S. Cl. CPC A62C 35/68; F16L 11/124; G09F 3/0295

(57) ABSTRACT

A method of installing a sprinkler assembly in a piping network uses a sleeve moved along a conduit to a position where the sleeve is visible from below the assembly. The sleeve has markings which are used in a method to visually identify one or more characteristics of the assembly. Because the markings are indicative of characteristics of the assembly they can be used in a method for inspecting an installed assembly.

### CROSS REFERENCE TO RELATED APPLICATIONS

This application is a divisional of U.S. patent application Ser. No. 14/178,915 filed Feb. 12, 2014, now abandoned, which is based upon and claims priority to U.S. Provisional Application No. 61/765,233, filed Feb. 15, 2013, both applications being hereby incorporated by reference.

### FIELD OF THE INVENTION

This invention relates to a sleeve positionable on a flexible conduit assembly for connecting sprinklers to branch lines in a fire suppression system, the sleeve serving to identify characteristics of the flexible conduit assembly for methods of visual inspection.

### BACKGROUND

Fire suppression sprinkler systems used, for example, in structures such as office buildings, hotels, warehouses and private residences have a piping network comprising a riser pipe connected to a source of pressurized fire suppressing fluid, for example, a liquid, such as water, or a gas, such as halon. Branch pipe lines are connected to the riser pipe at each floor of the structure and extend throughout each floor so that fire suppressing fluid may be delivered through the branch lines to any location on each floor. The branch lines are usually suspended on hangers attached to the structural ceiling of each floor. Sprinklers, which serve to discharge the fluid in the event of a fire, are connected to the branch lines by flexible conduits. The use of flexible conduits provides a great advantage as it allows the position of the sprinklers to be easily adjusted, both laterally and vertically, in relation to the decorative ceiling which may be suspended beneath the structural ceiling of each floor. The flexible conduit saves time during installation, as it obviates the need for the technician to install a rigid pipe assembly, comprised of threaded pipe elements and threaded fittings, to connect the branch line to each sprinkler head on the floor. With a rigid pipe assembly even a minor miscalculation, either in the design or installation, can be aesthetically and functionally unacceptable, and require a redesign and reinstallation.

As with many other fire safety related components, flexible conduits and the assemblies in which they are used must be approved into various categories by different agencies such as Underwriters' Laboratories (UL), the National Fire Protection Association (NFPA) and Factory Mutual (FM). Installations using approved components must be inspected and must pass inspection before they are given the stamp of approval which states that they meet the appropriate requirements.

Inspection of fire suppression sprinkler systems poses various practical problems due to the general inaccessibility of the sprinklers and their connecting conduits because they are often mounted high among ceiling structures, such as rafters or truss work, or above storage racks in warehouses high above the floor. In addition to the inaccessibility of the assemblies, inspection is further complicated by the fact that, from a distance, approved assemblies can be confused with non-approved assemblies or assemblies approved in other categories. A visual inspection of each sprinkler assembly therefore requires that an inspector mount a ladder, scaffolding, or a lift to view each assembly in detail to ensure that approved components which meet the requirements have been used. There is clearly a need for an identification device which makes inspection of sprinkler conduit assemblies easier to accomplish.

### SUMMARY

The invention concerns a method of installing a sprinkler assembly in a piping network. An example sprinkler assembly has a sprinkler attached to a flexible conduit and a sleeve surrounding a portion of the conduit. An example method comprises:
attaching one end of the flexible conduit in fluid communication with the piping network;
fixing the sprinkler in a desired position; and
moving the sleeve along the conduit to a position wherein the sleeve is visible from a position beneath the assembly.

The invention further encompasses a method of identifying at least one of a plurality of characteristics of a sprinkler assembly. By way of example the sprinkler assembly has a sprinkler attached to a flexible conduit. An example method comprises surrounding a portion of the flexible conduit with a sleeve. The sleeve has visible markings thereon indicative of at least one of the plurality of characteristics of the sprinkler assembly.

By way of example, the markings comprise a color field. In another example the markings comprise a pattern of contrasting colors. Further by way of example the markings comprise indicia. In an additional example the markings comprise symbols.

In an example method the characteristics are selected from the group consisting essentially of a manufacturer of the assembly, a length of the conduit, a diameter of the conduit, a sprinkler K factor, an agency listing, an agency category listing, and combinations thereof.

The method according to the invention also includes inspecting an assembly which, for example, uses a flexible conduit to connect a sprinkler to a piping network. In one example embodiment the method comprises observing a sleeve surrounding a portion of the flexible conduit from a position beneath the assembly and determining a characteristic of the assembly based upon markings visible on the sleeve.

By way of example the markings comprise a color field. In another example the markings comprise a pattern of contrasting colors. Further by way of example the markings comprise indicia. In an example the markings comprise symbols. In an example embodiment of the method the markings are indicative of a manufacturer of the assembly. In another example the markings are indicative of a length of the conduit. In a further example the markings are indicative of a diameter of the conduit. Also by way of example the markings are indicative of a sprinkler K factor. In another example the markings are indicative of an agency listing. Further by way of example the markings are indicative of an agency category listing.

### BRIEF DESCRIPTION OF THE DRAWINGS

FIG. 1 is an isometric view of an example sprinkler assembly embodiment according to the invention;

FIG. 2 is a side view of an example combination of a flexible conduit and sleeve according to the invention;

FIG. 3 is an isometric view of an example sleeve embodiment according to the invention; and

FIG. 4 is an isometric view of an example sleeve embodiment according to the invention.

### DETAILED DESCRIPTION

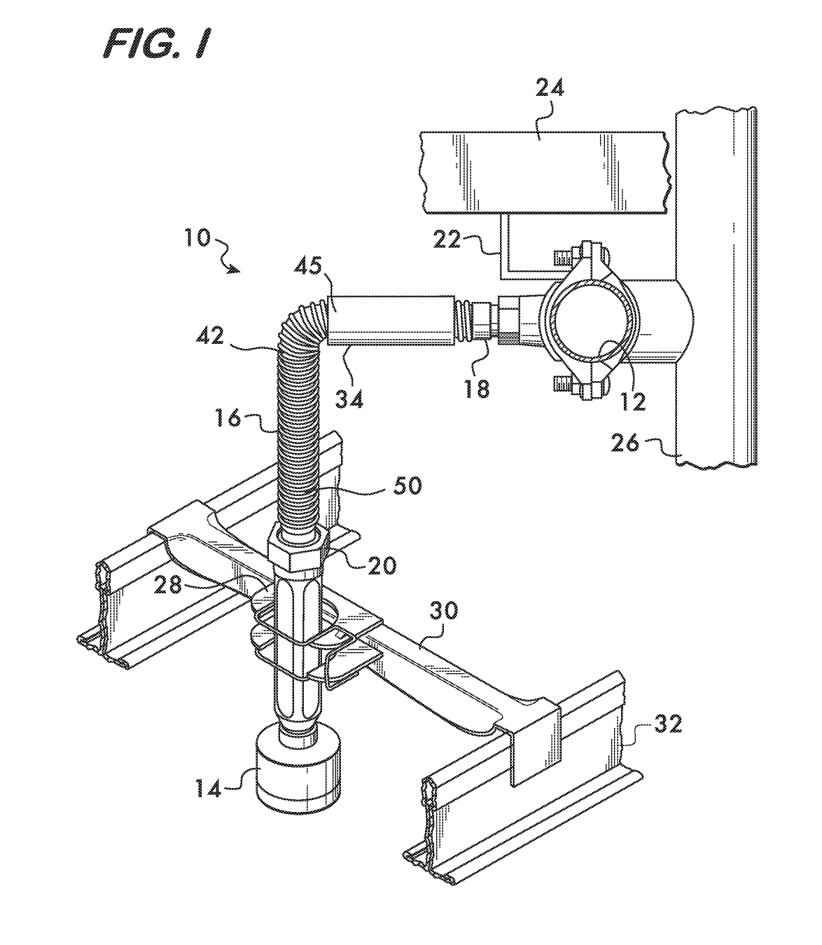

FIG. 1 shows an assembly 10 for connecting a branch line 12 of a fire suppression system to a sprinkler 14. Note that sprinkler is defined herein as any device which discharges a fire suppression fluid, and includes, but is not limited to, items such as sprinklers, heads, nozzles, emitters and the like, whether they be open or closed and open in response to a fire. Assembly 10 comprises a flexible conduit 16 which has a first end 18 connected to the branch line 12, and a second end 20 which is connected to the sprinkler 14. The branch line 12 is supported by a pipe hanger 22 attached to a portion of the structure in which the fire suppression system is mounted, in this example, to the structural ceiling 24 of a building. Branch line 12 is one of many branch lines connected to a riser pipe 26 in fluid communication with a pressurized source of a fire suppressing fluid, such as water (not shown). A portion of the assembly 10 near the second end 20 of the flexible conduit 16 is engaged by a bracket 28 that is mounted on a cross beam 30 which extends between and is mounted on support rails 32 which support a decorative ceiling, such as a suspended ceiling or a drop ceiling (not shown) intended to hide the structural ceiling 24. Other mounting configurations are also feasible, the configuration shown in FIG. 1 being by way of example only.

As shown in FIG. 1, a sleeve 34 covers a portion of the flexible conduit 16. Sleeve 34 is positioned on conduit 16 between first and second ends 18 and 20. In this example sleeve 34 is positioned near first end 18, where it may be highly visible to an inspector looking up from the ground beneath the installation. However, the sleeve 34 is slidably movable along the conduit 16 so that it may be positioned at any one of a plurality of positions between the first and second ends where it will be most easily seen.

As shown in detail in FIG. 3, sleeve 34 comprises a sidewall 36 that surrounds a central space 38. Central space 38 receives the flexible conduit 16. Sidewall 36 in this example is of unitary construction, meaning it has no seam. Sidewalls having seams however are also feasible. Sidewall 36 has an inner surface 40 which contacts the outer surface 42 of the conduit 16 (see FIG. 1). Friction between the inner surface 40 of sidewall 36 and the outer surface 42 of the conduit 16 may be used to hold the sleeve 34 in the desired position once that position has been determined.

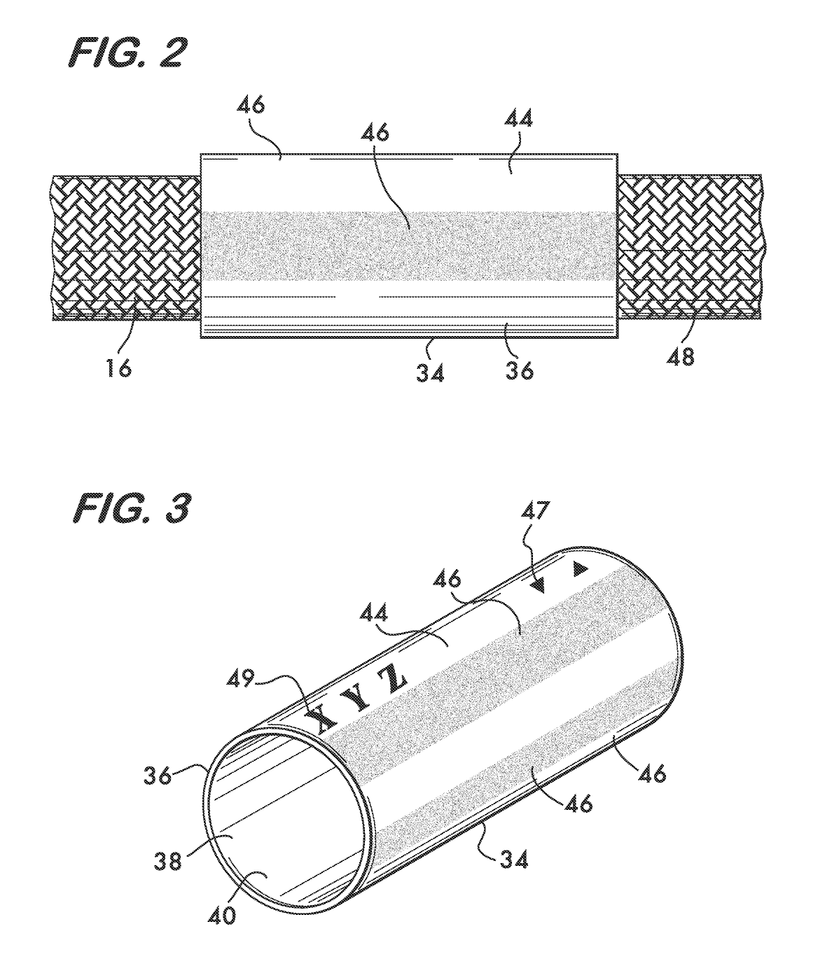

Sidewall 36 of sleeve 34 also has an outer surface 44. Outer surface 44 will be visible for inspection of the sprinkler assembly 10, and therefore it is advantageous to enhance its visibility. This may be done, for example, by having an outer surface 44 with a contrasting color from the conduit 16 (a “color field” 45, shown in FIG. 1). Highly visible colors, such as orange, are effective at enhancing the visibility. In addition to or instead of a color field, markings comprising patterns of contrasting color may be used. An example of such an embodiment is shown in FIGS. 2 and 3, where longitudinal stripes 46 of contrasting colors are found on the outer surface 44 of the sidewall 36 of the sleeve 34. Additionally, it is further advantageous to provide symbols 47 or indicia 49 on the outer surface 44 as shown in FIG. 3.

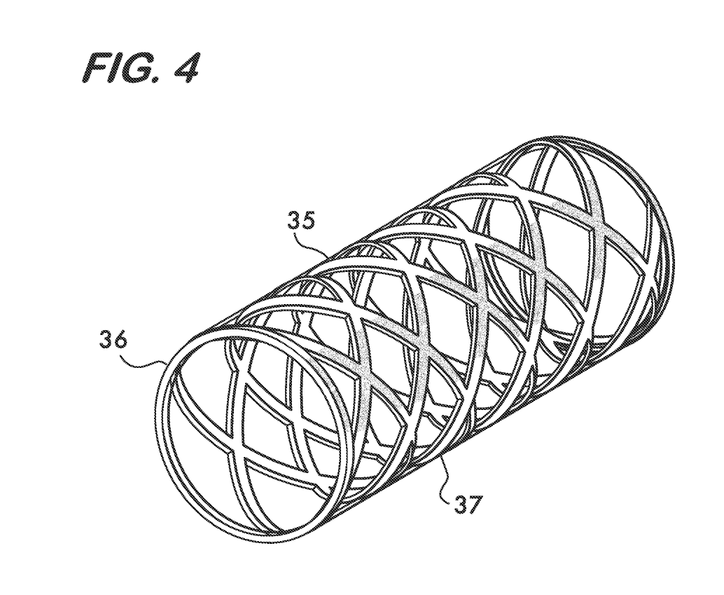

FIG. 4 illustrates a sleeve embodiment 35 wherein sidewall 36 comprises an open mesh 37. Mesh 37 may be woven, knitted, or braided for example, or may be extruded, continuously formed, or formed by perforating an otherwise solid sidewall.

It is also advantageous that the sidewall 36 of sleeves 34 or 35 be flexible so as to deform and accommodate the shape of the conduit 16. This flexibility will facilitate moving and positioning of the sleeve 34 along a curved conduit as well as permit the conduit 16 to deform relatively unhindered. To this end, the sleeves 34 and 35 may be made of flexible, resilient materials such as nylon, polyethylene as well as other polymer compounds.

FIG. 2 illustrates a combination flexible conduit 16 and sleeve 34. Sleeve 34 surrounds a portion of the conduit between its first and second ends (only one end being shown). In the example shown in FIG. 2, the flexible conduit 16 has a braided outer layer 48 formed of stainless steel wire. Other materials are of course feasible. The example embodiment of the conduit 16 shown in FIG. 1 has a corrugated outer layer 50. Other types of construction for the flexible conduit 16 are also feasible. Furthermore, it is understood that sleeve 35, comprising an open mesh (see FIG. 4), could also be used in combination with the conduit 16.

Sleeves 34 or 35 according to the invention used in combination with flexible conduits 16, for example, in fire suppression systems, permit the characteristics of the assembly or combination to be readily visually identified from a distance. This property of ready visual identification along with the ability to position the sleeve at a visible portion of the conduit greatly simplifies the work of inspectors, obviating the need for ladders, lifts and scaffolding. The sleeve may be used to indicate any of a number of characteristics of the assembly or combination, including, without limitation, the manufacturer, the length of the conduit, the diameter of the conduit, the type of sprinkler required for the conduit, the particular agency listing (e.g., Underwriters Laboratories, Factory Mutual Research Corporation, NSF International), the particular agency category listing, as well as other information.

What is claimed is:

1. A method of installing a sprinkler assembly in a piping network, the sprinkler assembly having a sprinkler attached to a flexible conduit and a sleeve surrounding a portion of said conduit, the method comprising:
attaching one end of said flexible conduit in fluid communication with said piping network;
fixing said sprinkler in a desired position; and
moving said sleeve along said conduit to a position wherein said sleeve is visible from a position beneath said assembly.

2. A method of identifying at least one of a plurality of characteristics of a sprinkler assembly, said sprinkler assembly having a sprinkler attached to a flexible conduit, said method comprising surrounding a portion of said flexible conduit with a sleeve, said sleeve having visible markings thereon indicative of at least one of said plurality of characteristics of said sprinkler assembly.

3. The method according to claim 2, wherein said markings comprise a color field.

4. The method according to claim 2, wherein said markings comprise a pattern of contrasting colors.

5. The method according to claim 2, wherein said markings comprise indicia.

6. The method according to claim 2, wherein said markings comprise symbols.

7. The method according to claim 2, wherein said characteristics are selected from the group consisting essentially of a manufacturer of said assembly, a length of said conduit, a diameter of said conduit, a sprinkler K factor, an agency listing, an agency category listing, and combinations thereof.

8. A method of inspecting an assembly using a flexible conduit to connect a sprinkler to a piping network, said method comprising:
observing a sleeve surrounding a portion of said flexible conduit from a position beneath said assembly;
determining a characteristic of said assembly based upon markings visible on said sleeve.

9. The method according to claim 8, wherein said markings comprise a color field.

10. The method according to claim 8, wherein said markings comprise a pattern of contrasting colors.

11. The method according to claim 8, wherein said markings comprise indicia.

12. The method according to claim 8, wherein said markings comprise symbols.

13. The method according to claim 8, wherein said markings are indicative of a manufacturer of said assembly.

14. The method according to claim 8, wherein said markings are indicative of a length of said conduit.

15. The method according to claim 8, wherein said markings are indicative of a diameter of said conduit.

16. The method according to claim 8, wherein said markings are indicative of a sprinkler K factor.

17. The method according to claim 8, wherein said markings are indicative of an agency listing.

18. The method according to claim 8, wherein said markings are indicative of an agency category listing.
